(19) United States
(12) Patent Application Publication
(10) Pub. No.: US 2026/0219458 A1
(43) Pub. Date: Jul. 30, 2026

(54) Molded Light Pipe Optical Turn

(71) Applicants: Albert T Yuen, Palo Alto, CA (US); Michael R Tan, Menlo Park, CA (US); Paul K Rosenberg, Samta Cruz, CA (US)

(72) Inventors: Albert T Yuen, Palo Alto, CA (US); Michael R Tan, Menlo Park, CA (US); Paul K Rosenberg, Samta Cruz, CA (US)

(21) Appl. No.: 19/458,811

(22) Filed: Jan. 25, 2026

Related U.S. Application Data
(60) Provisional application No. 63/750,457, filed on Jan. 28, 2025.

(51) Int. Cl. G02B 6/38

(52) U.S. Cl. CPC G02B 6/3829; G02B 6/3865

(57) ABSTRACT

An optical pipe has an entrance face; an exit face orthogonal to the entrance face; first and second mirrored surfaces at 45 degrees to the entrance and exit faces; and a 2xN array of waveguides. The array has a first row of N hollow waveguides, in which each waveguide has a first linear portion, orthogonal to the entrance face, from the entrance face to the first mirrored internal surface, and a second linear portion, orthogonal to the first straight portion, from the first mirrored internal surface to the exit face; and a second row of N hollow waveguides, in which each waveguide has a first linear portion, orthogonal to the entrance face, from the entrance face to the second mirrored internal surface and a second linear portion, orthogonal to the first straight portion, from the second mirrored internal surface to the exit face.

### CROSS-REFERENCES TO RELATED APPLICATIONS

This application claims priority from U.S. Provisional Patent Application Serial No. 63/750457 titled “Molded Light Pipe Optical Turn”, filed on January 28, 2025, which is hereby incorporated by reference as if set forth in full in this application for all purposes

### FIELD OF INVENTION

This invention relates to the general field of fiber-optic communications components, and in particular to connectors accomplishing low loss 90 degree turns for an array of optical paths.

### BACKGROUND

Passive components that can efficiently direct light between an array of semiconductor devices (e.g. lasers, LEDs, photodiodes) and a fiber cable carrying either one or multiple optical fibers are useful components for fiber-optic systems. Current commercially available components creating optical paths that include a 90 degree turn for such applications rely on free space optics, including a prism to provide a surface at which total internal reflection (TIR) occurs, thus accomplishing the turn with low optical loss. However, Moreover, fabrication complexity, with a need to achieve precise alignment between elements, makes such components costly. This is particularly significant where high bandwidth is desired, as in that case the fabrication is likely to require high precision alignment capable of low loss coupling 2-dimensional arrays of optical sources (or detectors) at one face and 2-dimensional arrays of fibers at another face, orthogonal to the first. This renders the TIR approach practically infeasible for such applications.

Therefore, there is a need for optical turn components that can be manufactured at low cost, as well as incurring low optical loss. Ideally, these components would be applicable to 2-dimensional as well as linear arrays of semiconductor devices and fibers.

### BRIEF DESCRIPTION OF DRAWINGS

FIG. 1 (Prior Art) is a perspective view of one example of a commercially available optical turn component.

FIG. 2 is a perspective view illustrating elements designed to be combined to form an optical turn component according to some embodiments of the present invention.

FIG. 3 shows perspective views illustrating the elements of the optical turn component shown in FIG. 2 in greater detail.

FIG. 4 shows perspective and side views of an assembled optical turn component according to some embodiments of the present invention.

### DETAILED DESCRIPTION

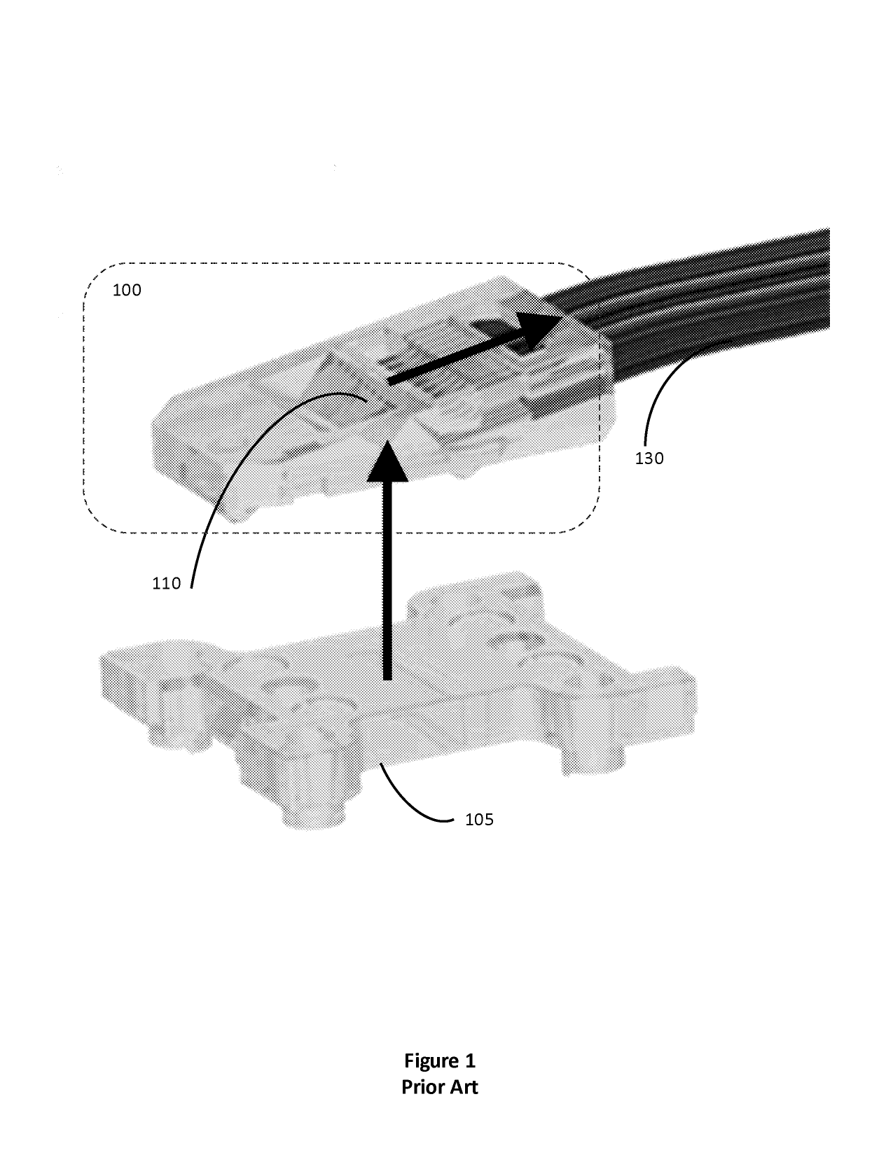

FIG. 1 (prior art) shows an example of a currently available light turn component, or optical pipe 100 that can conveniently direct an array of light beams between a one dimensional array of semiconductor devices in a board-mountable package 105 and a fiber ribbon 130 along paths that include a 90 degree turn. In this view, just one optical path is indicated (see bold arrows) representing a beam that first travels vertically upwards to enter and pass thorough the bottom face of prism 110 at right angles, then encounters the 45 degree angled prism face, where it undergoes TIR, and finally emerges orthogonally from the right-facing face of the prism, to enter one fiber in the horizontal flat fiber ribbon 130. One can readily envisage a linear array of such beams entering the prism and being turned to enter other corresponding fibers in the ribbon. Increasing prism size to accommodate 2-dimensional arrays is also technically feasible. As noted above, however, manufacturing cost can be a limiting factor in the practical application of this type of optical component.

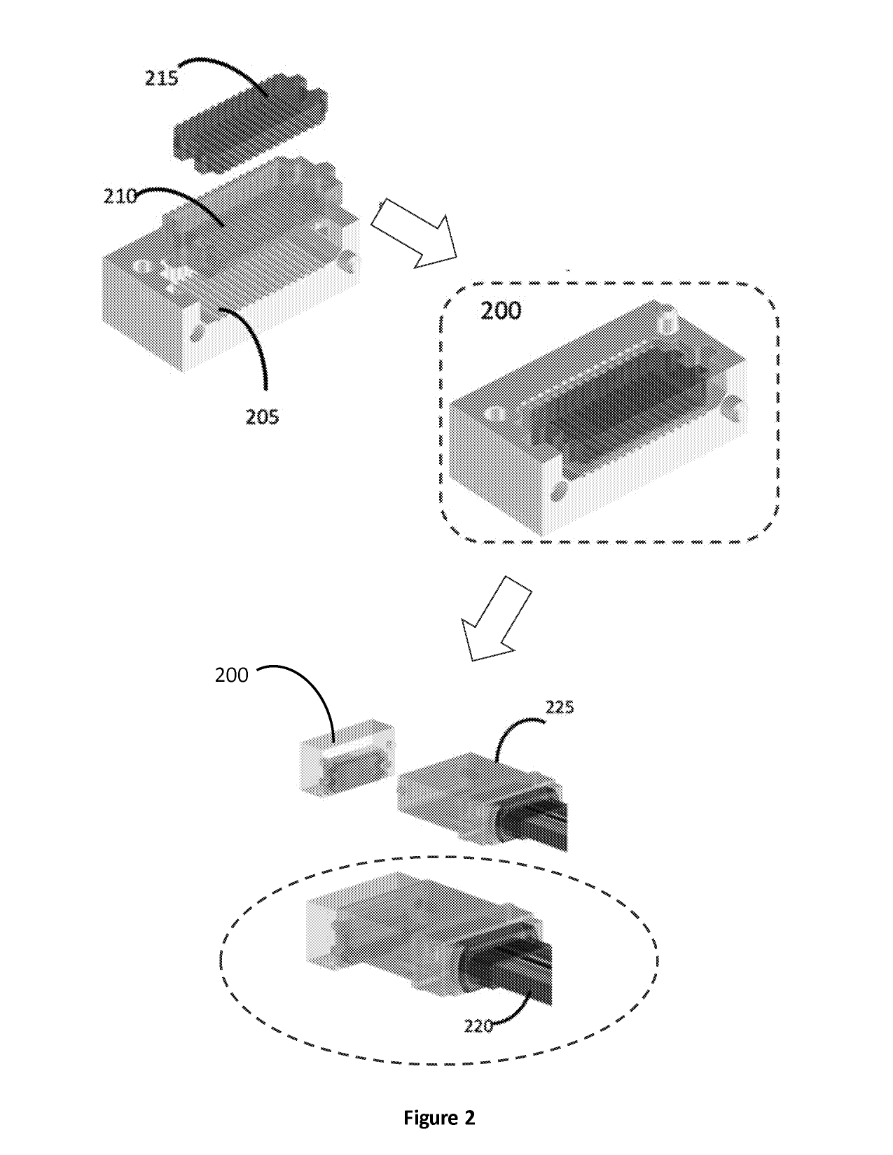

FIG. 2 shows perspective views of elements designed to be combined to form an optical turn component, or light pipe, 200 according to some embodiments of the present invention, the light pipe itself, and a standard fiber ferrule 225 to which it may connect. In the top left portion of the figure, three elements, base 205, midsection 210 and top 215 are shown separately, prior to assembly. Slightly lower, within the dashed outline, the three elements are shown after they have been fitted together into a block, forming the whole light pipe 200 that guides light paths along 90 degree turns, as will be discussed further below. The lowest portion of the figure shows assembled light pipe 200, first positioned close to fiber ferrule 225 (including an end portion of fiber cable 220) as the pipe and ferrule are being mutually aligned, and next, shown inside the dashed oval, the fully connected pipe-ferrule combination.

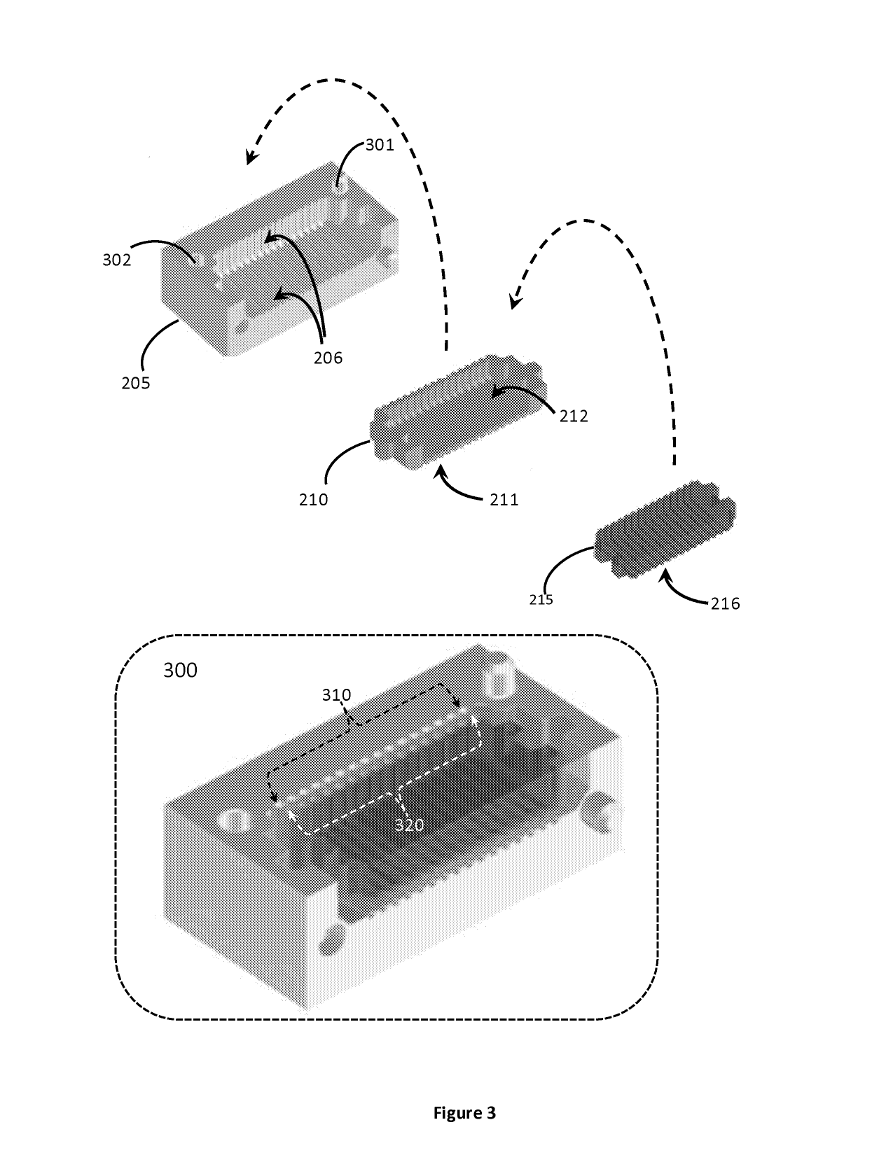

FIG. 3 shows perspective views illustrating each of the elements 205, 210 and 215 of the optical turn 200 shown in FIG. 2 separately, and then in place after assembly. Thermoplastic resins such as, for example, Ultem^{TM}, are attractive material choices for these parts, lending themselves to low cost molding and coating processes. Sets of half-waveguides are created as each of the three elements is fabricated, first by molding corrugations, either semi-circular or rectangular in cross-section, into some of the surfaces, and then coating the corrugated surfaces with a metal or metallic alloy which is highly (typically over 95%) reflective at the wavelengths of interest. This disclosure uses the term "mirrored" to describe such surfaces, which achieve high reflectivity by virtue of one or more coatings. Base 205 also includes molded precision alignment features, such as 301, 302, necessary for assembly of the three parts. In practice there may be more such features than those shown in this figure.

In the particular embodiment shown, designed to operate with a 2x16 array of semiconductor devices, base 205 includes a set of 16 coated half-waveguides molded intoits upper L-shaped surface 206, midsection 210 has one set of 16 coated half-waveguides molded into its lower L-shaped surface 211 (only the horizontal lower part of that surface is indicated by the arrow in the figure) and a second set of 16 coated half-waveguides molded into its upper surface 212. The top element 215 has one set of 16 coated half waveguides molded into its lower surface 216. The curved dashed arrows indicate how top element 215 can fit into midsection 210 and how midsection 210 can fit into base 205, to form light pipe component 300.

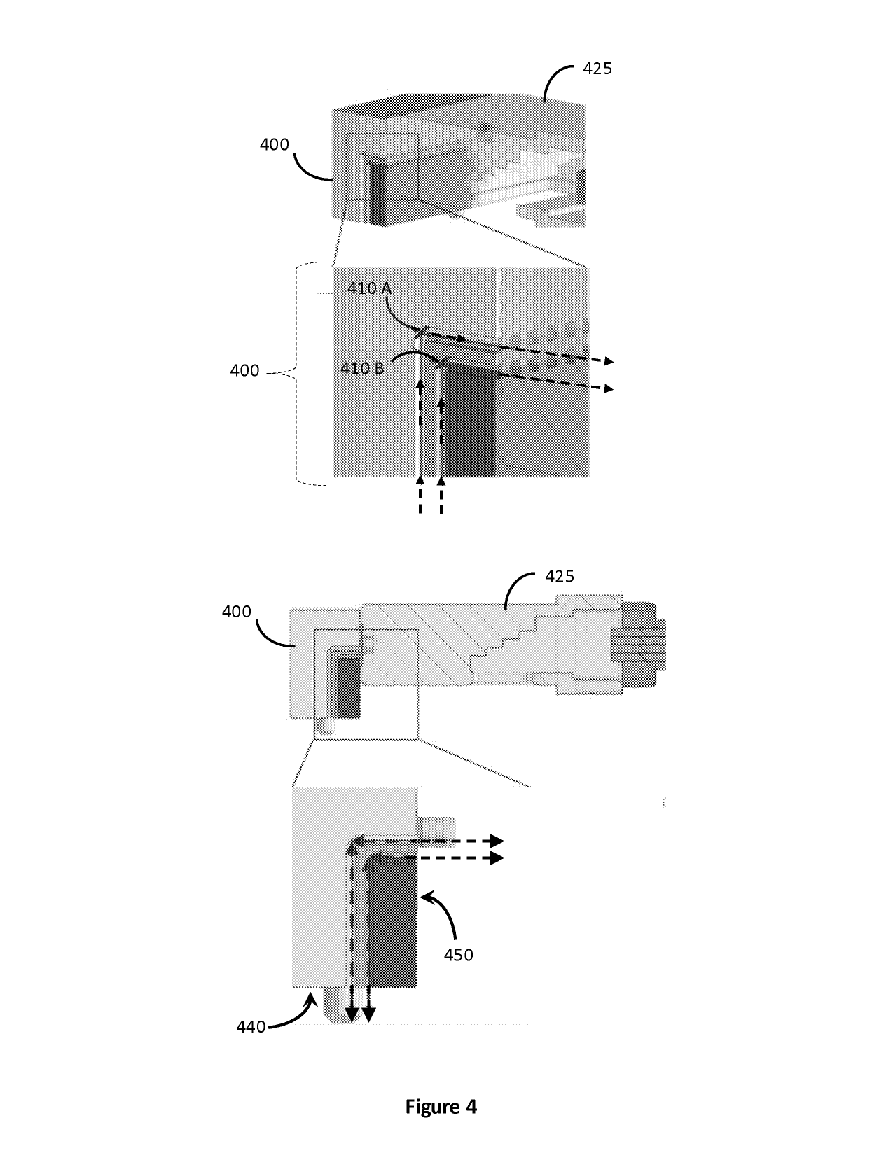

After assembly, the corrugations match up such that each full (completed) waveguide formed by the juxtaposition of two elements is hollow. Light coupled into one end of the waveguide emerges from the other end after undergoing a few (typically two or three) reflections at the metal-coated waveguide walls plus one 90-degree reflection at a 45-degree angled plane mirror surface, as will be discussed below with respect to FIG. 4. One set of 16 hollow waveguides 310 is formed by the juxtaposition of elements 205 and 210, while a second set of 16 hollow waveguides 320 is formed by the juxtaposition of elements 210 and 215.

The dimensions of the whole optical pipe 300 are small, being of the order of a few (<5) mm, with the cross sectional dimensions of the hollow waveguides chosen such that the paths taken by optical rays through them are at shallow angles to the groove (waveguide) axes, typically at less than 30 degrees relative to each groove axis, to minimize the number of wall reflections, and therefore minimize corresponding optical losses.

The combination of the 16 half-waveguides formed in base 205 and the 16 half-waveguides in outer surfaces of midsection 210 make up a set of complete outer waveguides 310 in which rays will travel longer paths through pipe 200 than the paths travelled by rays guided within the set of complete inner waveguides 320 formed by the combination of the 16 half-waveguides 212 (in the inner surfaces of midsection 210) and the 16 half-waveguides 216 formed in top section 215.

The top portion of FIG. 4 shows perspective views at different magnifications illustrating how assembled light pipe 400 guides optical paths through a 90 degree turn into a fiber ferrule 425. In the orientation shown, light from a 2xN transmitter array (not shown) below light pipe 400 enters light pipe 400, travels effectively vertically through the hollow waveguides as indicated by the dashed paths. Light from each row of the array will encounter a corresponding turn mirror 410A or 410B where it will be reflected to travel effectively horizontally to the right, to then enter ferrule 425 and eventually be guided into a fiber output array (not shown, but attached to the ferrule at the right in the orientation of the figure). The lower portion of FIG. 4 shows side views at different magnifications of the same arrangement, omitting the ferrule for simplicity, but this time the light paths are indicated by double sided arrows, to show that the light pipe may equally well be used to send light from the fiber ferrule to be received by a photodetector array (not shown) below light pipe 400. Light corresponding to one row of the transmitter (or receiver) array will travel along optical paths of a different length to light of the other row. In embodiments where light travels from a source array up through face 440 of light pipe 400, 440 may be termed an entrance face and face 450 an exit face. In embodiments where light travels from a fiber ferrule horizontally into face 450 of light pipe 400, 450 may be termed an entrance face and face 450 an exit face.

While the discussion so far has focused on embodiments shown in FIGS. 2-4, and refers mainly to 2x16 arrays, it should be appreciated that the same basic ideas of molding, coating and assembling three parts to form two sets of optical paths through hollow waveguides that achieve a 90 degree turn could be applied to 2xN arrays in general. Moreover, the ideas could be extended to the fabrication of turns assembled from four "nested" component parts rather than three, to deal with 3xN arrays, and so on.

It should also be appreciated that focusing optics may be included at the transmitter (or receiver) arrays and/or the ferrule, to maximize coupling efficiency into or out of the optical pipe. Another reason for doing this would be to adjust or control spacing between the optical beams in the array of beams passing through the optical pipe, allowing the optical pipe to accommodate different array patterns, according to the specific design of the transmitter, receiver, or fiber arrays involved.

This disclosure teaches just few examples of illustrative embodiments. It should be understood that many variations of the invention can easily be devised by those skilled in the art after reading this disclosure, and that the scope of the present invention is to be determined by the following claims.

1. An optical pipe comprising:
an entrance face;
an exit face orthogonal to the entrance face;
first and second mirrored surfaces at 45 degrees to the entrance and exit faces; and
a 2xN array of waveguides comprising:
a first row of N hollow waveguides, each waveguide comprising a first linear portion, orthogonal to the entrance face, from the entrance face to the first mirrored internal surface, and a second linear portion, orthogonal to the first straight portion, from the first mirrored internal surface to the exit face; and
a second row of N hollow waveguides, each waveguide comprising a first linear portion, orthogonal to the entrance face, from the entrance face to the second mirrored internal surface and a second linear portion, orthogonal to the first straight portion, from the second mirrored internal surface to the exit face.

2. The optical pipe of claim 1,
wherein N = 16.

3. The optical pipe of claim 1, further comprising:
a third mirror surface at 45 degrees to the entrance and exit faces; and
a third row of N hollow waveguides, each waveguide comprising a first linear portion, orthogonal to the entrance face, from the entrance face to the third mirrored internal surface and a second linear portion, orthogonal to the first straight portion, from the third mirrored internal surface to the exit face.

4. An optical pipe comprising:
a base element, comprising:
a first base surface comprising N metal-coated grooves;
a second base surface, orthogonal to the first base surface, comprising N metal-coated grooves; and
a third base surface meeting the first and second base surfaces at 45 degrees, comprising a first mirror;
a midsection block comprising:
a first midsection surface comprising N metal-coated grooves;
a second midsection surface, meeting the first midsection surface at 90 degrees, comprising N metal coated grooves;
a third midsection surface comprising N metal-coated grooves;
a fourth midsection surface, orthogonal to the third midsection surface, comprising N metal coated grooves; and
a fifth midsection surface meeting the third and fourth midsection surfaces at 45 degrees, comprising a second mirror; and
a top block comprising:
a first top surface comprising N metal-coated grooves; and
a second top surface, meeting the first base surface at 90 degrees, comprising N metal coated grooves;
wherein the first and second midsection surfaces contact the first and second base surfaces such that a first set of N hollow waveguides are formed therebetween;
wherein the third and fourth midsection surfaces contact the first and second top surfaces such that a second set of N hollow waveguides are formed therebetween; and
wherein the first and second mirrors reflect guided optical beams through 90 degrees during passage of the guided optical beams through the first and second set of N hollow waveguides respectively.

5. The optical pipe of claim 4,
wherein the base, midsection, and top blocks comprise a thermoplastic resin.

6. A method of fabricating an optical pipe; the method comprising:
molding a base component such that the base component comprises:
a first base surface comprising N parallel grooves;
a second base surface, orthogonal to the first base surface, comprising N parallel grooves; and
a third base surface, meeting the first and second base surfaces at 45 degrees;
molding a midsection component such that the midsection comprises:
a first midsection surface comprising N parallel grooves;
a second midsection surface, meeting the first midsection surface at 90 degrees, comprising N parallel grooves;
a third midsection surface comprising N parallel grooves;
a fourth midsection surface, orthogonal to the third midsection surface, comprising N parallel grooves; and
a fifth midsection surface meeting the third and fourth midsection surfaces at 45 degrees;
molding a top component such that the top component comprises:
a first top surface comprising N parallel grooves; and
a second top surface, meeting the first base surface at 90 degrees, comprising N parallel grooves; and
depositing a reflective coating over:
the grooves in each of the base, midsection, and top components;
the third base surface; and
the fifth midsection surface.

7. The method of claim 6 further comprising:
inserting the coated midsection component into the coated base component such that the first and second midsection surfaces contact the first and second base surfaces forming a first set of N hollow waveguides therebetween; and
inserting the coated top component into the coated midsection component such that the third and fourth midsection surfaces contact the first and second top surfaces forming a second set of N hollow waveguides therebetween.

8. The method of claim 6 further comprising:
molding fiducials into the base component such that attachment of the coated base component to a semiconductor optical source or transmitter and to a fiber ferrule is facilitated.
